(19) United States
(12) Patent Application Publication
(10) Pub. No.: US 2025/0263515 A1
(43) Pub. Date: Aug. 21, 2025

(54) METHOD FOR MANUFACTURING CURED PRODUCT FOR HOLOGRAPHIC RECORDING MEDIUM

(71) Applicant: Mitsubishi Chemical Corporation, Tokyo (JP)

(72) Inventors: Asato TANAKA, Tokyo (JP); Ken SATO, Tokyo (JP); Kazuma INOUE, Tokyo (JP)

(73) Assignee: Mitsubishi Chemical Corporation, Tokyo (JP)

(21) Appl. No.: 19/196,219

(22) Filed: May 1, 2025

Related U.S. Application Data
(63) Continuation of application No. PCT/JP2023/040730, filed on Nov. 13, 2023.

(30) Foreign Application Priority Data
Nov. 14, 2022 (JP) 2022-181979

(51) Int. Cl. C08G 18/42; C08G 18/22; G03H 1/18

(52) U.S. Cl. CPC C08G 18/4277; C08G 18/227; G03H 1/18; G03H 2001/185

(57) ABSTRACT

A method for producing a cured product for a holographic recording medium by curing a composition for a holographic recording medium, the composition containing a compound (a) having an isocyanate group and a compound (b) having an isocyanate-reactive functional group. The curing reaction includes a curing step A in which the composition is cured at a temperature lower than 35° C., and the remaining rate of unreacted isocyanate groups after the curing step A is 10% or less of the isocyanate groups in the composition for a holographic recording medium before the curing reaction.

### CROSS-REFERENCE TO RELATED APPLICATIONS

The present application is a continuation of International Patent Application PCT/JP2023/040730, filed Nov. 13, 2023, which is based on and claims the benefit of priority to Japanese Application No. 2022-181979, filed Nov. 14, 2022. The entire contents of these applications are incorporated herein by reference.

### TECHNICAL FIELD

The present invention relates to a method for manufacturing a cured product for a holographic recording medium by curing a composition for a holographic recording medium.

### BACKGROUND ART

A holographic recording medium, which has been attracting attention in recent years, is a recording medium that utilizes light interference and diffraction phenomena. A hologram is a recording method in which an interference pattern created by interference fringes of two lights (referred to as recording lights) called a reference light and an object light (also referred to as information light or signal light) is three-dimensionally recorded inside a recording medium. A holographic recording medium contains a photosensitive material in its recording layer. In a holographic recording medium, interference patterns are recorded by chemically changing the photosensitive material in accordance with the interference pattern and locally changing its optical properties.

A holographic recording medium has been developed for memory applications. As another use of the holographic recording medium, studies are being conducted to apply it to optical element such as light guide plate for AR glass, and the like. In the case of AR glass (AR glasses) applications, the holographic recorded optical element used in the light guide plate is required to have a wide viewing angle, high diffraction efficiency for light in the visible region, and high transparency of the medium.

A holographic recording medium can be classified into several types depending on what kind of optical properties are changed. It has been considered that a volume type hologram recording medium, which performs recording by creating a refractive index difference within a recording layer having a thickness more than a certain thickness, is advantageous for applications to a light guide plate of AR glass, because it can save space and achieve high diffraction efficiency and wavelength selectivity.

An example of a volume type holographic recording medium is a write-once type which does not require wet processing or bleaching. A composition of a recording layer of the write-once type is generally one in which a photoactive compound is compatibilized in a matrix resin. For example, it is known to use a photopolymer as a recording layer, in which a matrix resin is combined with a photoactive compound, the photoactive compound being a combination of a photopolymerization initiator and a polymerizable reactive compound capable of radical polymerization or cationic polymerization (Patent Literatures 1-4).

When recording holograms, if there is a recording layer made of photopolymer in an area where interference patterns are formed by intersection of reference light and object light, a photopolymerization initiator causes a chemical reaction and becomes an active substance in the area of high light intensity among the interference patterns. This then acts on the polymerizable compound, causing it to polymerize. In this process, if there is a difference in refractive index between a matrix resin and a polymer generated from the polymerizable compound, the interference patterns are fixed in the recording layer as a difference in refractive index. In addition, when the polymerizable compound polymerizes, diffusion of the polymerizable compound occurs from a periphery thereof, causing a concentration distribution of the polymerizable compound or its polymerized product inside the recording layer. Based on this principle, an interference pattern is recorded on the holographic recording medium as a refractive index difference.

Hereinafter, the process of changing the optical characteristics of the recording layer by exposing the recording layer of the medium under predetermined conditions as described above will be referred to as “recording exposure.” The process of recording and exposing different interference patterns at the same position by changing the intersection angle between the reference light and the object light or by changing their respective angles of incidence will be referred to as “multiplex recording exposure”.

### CITATION LIST

### Patent Literature

Patent Literature 1: JP2021-12249A
Patent Literature 2: JP2007-34334A
Patent Literature 3: JPH8-160842A
Patent Literature 4: JP2003-156992A
Patent Literature 5: JP2021-162621A

### Non-Patent Literature

Non-patent Literature 1: Junpei Tsujiuchi, “Physics Selection 22 Holography”

### SUMMARY OF INVENTION

### Technical Problem

When a volume hologram recording medium is used for an AR glass light guide plate or a head mounted display, multiple recording exposures called reflection holograms are performed. It is known that the diffraction efficiency of reflection holograms decreases depending on the polarization state of light (Non-Patent Literature 1). In other words, there is a problem that the desired diffraction efficiency cannot be obtained when light is guided through a light guide plate with a high birefringence, because the polarization state is different from the intended one.

For this reason, as with general resins, when producing a cured product for a hologram recording medium, it is necessary to cure the matrix resin so that birefringence does not occur. However, the inventors' investigation revealed a problem that if the curing reaction is accelerated by heating during the curing process of the matrix resin in order to shorten the time it takes for the curing reaction to converge, birefringence occurs due to cooling after curing. This problem is an issue for light guide plates used for AR glass light guide plates and head mounted displays. For this reason, the problem cannot be solved by only having a small in-plane phase difference (or two-dimensional birefringence) as described in Patent Literature 5.

The present invention has been made in consideration of such problems. An object of the present invention is to provide a cured product for a holographic recording medium with a small three-dimensional birefringence.

### Solution to Problem

The inventors' research has revealed that a cured product for a holographic recording medium with a small three-dimensional birefringence can be produced by slowly curing the product without heating until the residual rate of unreacted isocyanate groups in the matrix resin in the cured product for a holographic recording medium (hereinafter referred to as the NCO residual rate) becomes a certain amount or less. This makes it possible to obtain a reflective hologram with high diffraction efficiency without changing the polarization state of the light guided through the holographic recording medium. That is, the gist of the present invention is as follows.
[1] A method for producing a cured product for a holographic recording medium comprising:
   performing a curing reaction for by curing a composition for a holographic recording medium,
   wherein the composition comprises a compound (a) having an isocyanate group and a compound (b) having an isocyanate-reactive functional group,
   the curing reaction includes a curing step A in which the composition is cured at a temperature lower than 35° C., and
   a remaining rate of unreacted isocyanate groups after the curing step A is 10% or less relative to the isocyanate groups in the composition for a holographic recording medium before the curing reaction.
[2] The method for producing a cured product for a holographic recording medium according to [1], wherein the curing reaction includes a curing step B in which the composition is cured at a temperature of 35° C. or higher.
[3] The method for producing a cured product for a holographic recording medium according to [2], wherein the temperature of the curing step B is 150° C. or lower.
[4] The method for producing a cured product for a holographic recording medium according to [2] or [3], wherein the composition for a holographic recording medium comprises a bismuth-based catalyst as a component (f).
[5] The method for producing a cured product for a holographic recording medium according to [4], wherein the bismuth-based catalyst is at least one compound selected from the group consisting of tris(2-ethylhexanate)bismuth, tribenzoyloxybismuth, bismuth triacetate, bismuth tris(dimethyldicarbamate), bismuth hydroxide, triphenylbismuth (V)bis(trichloroarrelate), tris(4-methylphenyl)oxobismuth (V), and triphenylbis(3-chlorobenzoyloxy)bismuth (V).
[6] The method for producing a cured product for a holographic recording medium according to [4] or [5], wherein the content of the component (f) in the composition for a holographic recording medium is 0.001% by mass or more and 5% by mass or less.
[7] The method for producing a cured product for a holographic recording medium according to any one of [1] to [6], wherein the compound (b) having an isocyanate-reactive functional group has one or more hydroxyl groups in one molecule.
[8] The method for producing a cured product for a holographic recording medium according to any one of [1] to [7], wherein the compound (b) having an isocyanate-reactive functional group is at least one compound having two or more hydroxyl groups in one molecule selected from the group consisting of polyester polyols, polyether polyols, and polycarbonate polyols.
[9] The method for producing a cured product for a holographic recording medium according to any one of [1] to [7], wherein the compound (b) having an isocyanate-reactive functional group is at least one compound selected from polycaprolactone polyols having two or more hydroxyl groups in one molecule.
[10] The method for producing a cured product for a holographic recording medium according to any one of [1] to [9], wherein the content of the compound (b) having an isocyanate-reactive functional group in the composition for a holographic recording medium is 10% by mass or more and 85% by mass or less.
[11] The method for producing a cured product for a holographic recording medium according to any one of [1] to [10], wherein the compound (a) having an isocyanate group is at least one compound selected from polyisocyanates having an isocyanurate structure.
[12] The method for producing a cured product for a holographic recording medium according to any one of [1] to [11], wherein the content of the compound (a) having an isocyanate group in the composition for a holographic recording medium is 10% by mass or more and 85% by mass or less.

### Advantageous Effects of Invention

According to the present invention, by slowly curing in the curing step A at less than 35° C. until the residual NCO rate is below a certain amount, it is possible to produce a cured product for a holographic recording medium with a small three-dimensional birefringence. This makes it possible to obtain a reflective hologram with high diffraction efficiency.

### BRIEF DESCRIPTION OF DRAWINGS

FIG. 1 is a schematic diagram showing the configuration of the birefringence measuring device used in Examples.

### DESCRIPTION OF EMBODIMENTS

The following describes the embodiment of the present invention in detail. The products and methods exemplified below are examples (representative examples) of the embodiment of the present invention, and the present invention is not limited to these contents as long as they do not deviate from the gist of the invention.

The method for producing a cured product for a holographic recording medium of the present invention is a method for producing a cured product for a holographic recording medium by curing a composition for a holographic recording medium containing a compound (a) having an isocyanate group and a compound (b) having an isocyanate-reactive functional group. The curing reaction includes a curing step A in which curing is performed at lower than 35° C. The remaining rate of unreacted isocyanate groups after the curing step A is 10% or less of the isocyanate groups in the composition for a holographic recording medium before the curing reaction.

The curing reaction in the present invention preferably includes a curing step B in which curing is performed at 35° C. or higher.

Hereinafter, the composition for a holographic recording medium containing a compound (a) having an isocyanate group (hereinafter sometimes referred to as “component (a)”) and a compound (b) having isocyanate-reactive functionality (hereinafter sometimes referred to as “component (b)”) to be cured in the method for producing a cured product for a holographic recording medium of the present invention may be referred to as the “composition for a holographic recording medium of the present invention”. The cured product for holographic recording media produced by the method for producing a cured product for holographic recording media of the present invention may be referred to as the “cured product for holographic recording media of the present invention.”

### [Composition for Holographic Recording Media]

The composition for holographic recording media of the present invention contains a compound (a) having an isocyanate group and a compound (b) having an isocyanate-reactive functional group. The composition for holographic recording media contains preferably the following components (a) to (e). The composition for holographic recording media of the present invention may further contain the following component (f).
Component (a): Compound (a) having an isocyanate group
Component (b): Compound (b) having an isocyanate-reactive functional group
Component (c): Polymerizable monomer
Component (d): Photopolymerization initiator
Component (e): Compound having a nitroxyl radical group
Component (f): Curing catalyst
   <Component (a)>

The compound (a) in the component (a) having an isocyanate group is a component that reacts with the compound (b) having an isocyanate-reactive functional group (component (b)) in the presence of the curing catalyst (component (f)) described later to form a resin matrix.

The proportion of isocyanate groups in the molecule of the compound (a) having an isocyanate group is preferably 50% by mass or less, more preferably 47% by mass or less, and even more preferably 458 by mass or less. The lower limit is usually 0.18 by mass or more, and preferably 18 by mass or more. If the proportion of isocyanate groups is equal to or less than the upper limit, the holographic recording medium is less likely to become cloudy, and optical uniformity can be obtained. If the proportion of isocyanate groups is equal to or greater than the lower limit, the hardness and glass transition temperature of the resin matrix are increased, and loss of recording can be prevented.

The proportion of isocyanate groups in the present invention indicates the proportion of isocyanate groups in the entire compound (a) having an isocyanate group used. The proportion of isocyanate groups in the compound (a) having an isocyanate group is calculated from the following formula: The molecular weight of the isocyanate group is 42.

(42·number of isocyanate groups/molecular weight of compound (a) having an isocyanate group)·100

There is no particular restriction on the type of compound (a) having an isocyanate group, and it may have an aromatic, araliphatic, aliphatic, or alicyclic skeleton, for example.

The compound (a) having an isocyanate group may have one isocyanate group in the molecule, or may have two or more isocyanate groups. As the compound (a) having an isocyanate group, a polyfunctional isocyanate having two or more isocyanate groups is preferable. This is because a recording layer having excellent record retention can be obtained by using a three-dimensional crosslinked matrix obtained from the compound (a) (component (a)) having two or more isocyanate groups in the molecule and the compound (b) (component (b)) having three or more isocyanate groups in the molecule, or the compound (a) (component (a)) having three or more isocyanate groups in the molecule and the compound (b) (component (b)) having two or more isocyanate reactive functional groups in the molecule.

Examples of compounds (a) having an isocyanate group include isocyanic acid, butyl isocyanate, octyl isocyanate, butyl diisocyanate, hexamethylene diisocyanate (HMDI), isophorone diisocyanate (IPDI), 1,8-diisocyanato-4-(isocyanatomethyl) octane, 2,2,4- or 2,4,4-trimethylhexamethylene diisocyanate, isomeric bis(4,4′-isocyanatocyclohexyl) methane, and a mixture thereof having an arbitary content of an isomer, isocyanatomethyl-1,8-octane diisocyanate, 1,4-cyclohexylene diisocyanate, isomeric cyclohexanedimethylene diisocyanate, 1,4-phenylene diisocyanate, 2,4- or 2,6-toluene diisocyanate, 1,5-naphthalene diisocyanate, 2,4′- or 4,4′-diphenylmethane diisocyanate, and triphenylmethane 4,4′,4″-triisocyanate.

In addition, isocyanate derivatives having a urethane, urea, carbodiimide, acrylic urea, isocyanurate, allophanate, biuret, oxadiazinetrione, uretdione, and/or iminooxadiazinedione structure can also be used as the compound (a) having an isocyanate group.

Among these, in order to record high diffraction efficiency as a holographic recording medium, it is preferable that the matrix resin has a low refractive index, and therefore it is preferable that the compound (a) having an isocyanate group has an aliphatic or alicyclic skeleton. Examples thereof include hexamethylene diisocyanate (HMDI), isophorone diisocyanate (IPDI), 1,8-diisocyanato-4-(isocyanatomethyl) octane, 2,2,4- or 2,4,4-trimethylhexamethylene diisocyanate, isomeric bis(4,4′-isocyanatocyclohexyl) methane, and a mixture thereof having any desired isomer content, isocyanatomethyl-1,8-octane diisocyanate, 1,4-cyclohexylene diisocyanate, isomeric cyclohexanedimethylene diisocyanate; and polyisocyanates having a urethane, urea, carbodiimide, acrylic urea, isocyanurate, allophanate, biuret, oxadiazinetrione, uretdione and/or iminooxadiazinedione structure derived therefrom.

Among these, polyisocyanates having an isocyanurate, allophanate or uretdione structure, which have low viscosity, are more preferred from the viewpoint of miscibility with the compound (b) having an isocyanate-reactive functional group during production.

These compounds (a) having an isocyanate group may be used alone or in any combination and ratio of two or more.

<Component (b)>

The compound (b) having an isocyanate-reactive functional group of the component (b) is a compound having an active hydrogen (isocyanate-reactive functional group) that participates in the chain extension reaction with the compound (a) having an isocyanate group of the component (a).

Examples of the isocyanate-reactive functional group include a hydroxyl group, an amino group, and a mercapto group. The compound (b) having an isocyanate-reactive functional group may have one isocyanate-reactive functional group in the molecule, or may have two or more. It is preferable that the compound (b) having an isocyanate-reactive functional group has two or more isocyanate-reactive functional groups. In the case where the compound has two or more isocyanate-reactive functional groups, the isocyanate-reactive functional groups contained in one molecule may be one type or multiple types.

In order to improve compatibility with other components and obtain recording with high diffraction efficiency, the compound (b) having an isocyanate-reactive functional group is preferably a compound having one or more hydroxyl groups in one molecule.

The number average molecular weight of the compound (b) having an isocyanate-reactive functional group is usually 50 or more, preferably 100 or more, more preferably 150 or more, and usually 50,000 or less, preferably 10,000 or less, more preferably 5,000 or less. When the number average molecular weight of the compound (b) having an isocyanate-reactive functional group is equal to or greater than the lower limit, the crosslink density decreases, and a decrease in the recording speed can be prevented. When the number average molecular weight of the compound (b) having an isocyanate-reactive functional group is equal to or less than the upper limit, the compatibility with other components is improved and the crosslink density is increased, and therefore the loss of recorded content can be prevented.

The number average molecular weight of the component (b) is a value measured by gel permeation chromatography (GPC).

### (Compound Having a Hydroxyl Group)

The compound having a hydroxyl group as an isocyanate-reactive functional group may have one or more hydroxyl groups in one molecule, but preferably has two or more hydroxyl groups. Examples of such compounds include glycols such as ethylene glycol, triethylene glycol, diethylene glycol, polyethylene glycol, propylene glycol, polypropylene glycol (PPG), and neopentyl glycol; diols such as butanediol, pentanediol, hexanediol, heptanediol, tetramethylene glycol (TMG), and polytetramethylene glycol (PTMG); bisphenols; triols such as glycerin, trimethylolpropane, butanetriol, pentanetriol, hexanetriol, and decanetriol; compounds in which these polyfunctional alcohols are modified with a polyethyleneoxy chain or a polypropyleneoxy chain; polyfunctional polyoxybutylene; polyfunctional polycaprolactone; polyfunctional polyester; polyfunctional polycarbonate; and polyfunctional polypropylene glycol, and the like.

Any one of these compounds may be used alone, or two or more of them may be used in any combination and at any ratio.

The number average molecular weight of the compound having a hydroxyl group is usually 50 or more, preferably 100 or more, more preferably 150 or more, and usually 50,000 or less, preferably 10,000 or less, more preferably 5,000 or less. If the number average molecular weight of the compound having a hydroxyl group is equal to or greater than the lower limit, the crosslink density decreases, and a decrease in recording speed can be prevented. If the number average molecular weight of the compound having a hydroxyl group is equal to or less than the upper limit, the compatibility with other components is improved and the crosslink density is increased, preventing the loss of recorded content.

### (Compound Having an Amino Group)

The compound having an amino group as an isocyanate-reactive functional group may have one or more amino groups in one molecule, but it is preferable that the compound has two or more amino groups. Examples of such amines include aliphatic amines such as ethylenediamine, diethylenetriamine, triethylenetetramine, and hexamethylenediamine; alicyclic amines such as isophoronediamine, menthanediamine, and 4,4′-diaminodicyclohexylmethane; and aromatic amines such as m-xylylenediamine, diaminodiphenylmethane, and m-phenylenediamine.

Any one of these may be used alone, or two or more may be used in any combination and ratio.

The number average molecular weight of the compound having an amino group is usually 50 or more, preferably 100 or more, and more preferably 150 or more, and usually 50,000 or less, preferably 10,000 or less, and more preferably 5,000 or less. When the number average molecular weight of the compound having an amino group is equal to or greater than the lower limit, the crosslink density decreases, and a decrease in the recording speed can be prevented. When the number average molecular weight of the compound having an amino group is equal to or less than the upper limit, the compatibility with other components is improved, and the crosslink density is increased, so that loss of recorded content can be prevented.

### (Compound Having a Mercapto Group)

The compound having a mercapto group as an isocyanate-reactive functional group may have one or more mercapto groups in one molecule, but preferably has two or more mercapto groups. Examples of these include 1,3-butanedithiol, 1,4-butanedithiol, 2,3-butanedithiol, 1,2-benzenedithiol, 1,3-benzenedithiol, 1,4-benzenedithiol, 1,10-decanedithiol, 1,2-ethanedithiol, 1,6-hexanedithiol, 1,9-nonanedithiol, pentaerythritol tetrakis(3-mercaptopropionate), pentaerythritol tetrakis(2-mercaptoacetate), pentaerythritol tetrakis(3-mercaptobutyrate), trimethylolpropane tris(3-mercaptopropionate), dipentaerythritol hexakis (3-mercaptopropionate), 1,4-bis(3-mercaptobutyryloxy) butane, and the like.

Any one of these may be used alone, or two or more may be used in any combination and ratio.

The number average molecular weight of the compound having a mercapto group is usually 50 or more, preferably 100 or more, more preferably 150 or more, and usually 50,000 or less, preferably 10,000 or less, more preferably 5,000 or less. When the number average molecular weight of the compound having a mercapto group is equal to or greater than the lower limit, the crosslink density decreases, and a decrease in recording speed can be prevented. When the number average molecular weight of the compound having a mercapto group is equal to or less than the upper limit, the compatibility with other components is improved and the crosslink density is increased, preventing the loss of recorded content.

### (Suitable Component (b))

As component (b), it is preferable to use polycaprolactones from the viewpoints of material stability and structural flexibility.

Examples of polycaprolactones used as component (b) include polycaprolactone polyols (polycaprolactone diol, polycaprolactone triol, etc.) obtained by ring-opening polymerization of ε-caprolactone in the presence of polyhydric alcohols such as ethylene glycol, diethylene glycol, triethylene glycol, propylene glycol, dipropylene glycol, 1,3-butanediol, 1,4-butanediol, hexamethylene glycol, methylpentanediol, 2,4-diethylpentanediol, neopentyl glycol, 2-ethyl-1,3-hexanediol, trimethylolpropane, ditrimethylolpropane, pentaerythritol, dipentaerythritol, etc., or diols such as polypropylene glycol and polytetramethylene glycol (PTMG).

These may be used alone or in any combination and ratio of two or more.

<Component (c)>

The polymerizable monomer of component (c) is a compound that can be polymerized by the photopolymerization initiator of component (d) described below.

Component (c) is a monomer compound that is polymerized during recording and/or post-exposure.

The type of polymerizable monomer used in the composition for holographic recording media of the present invention is not particularly limited, and can be appropriately selected from known compounds. Examples of polymerizable monomers include cationic polymerizable monomers, anionic polymerizable monomers, and radical polymerizable monomers. Any of these can be used, and two or more types may be used in combination. However, it is preferable to use a radical polymerizable monomer as component (c) because the compound (a) having an isocyanate group and the compound (b) having an isocyanate-reactive functional group are less likely to inhibit the reaction that forms the matrix.

### (Cationic Polymerizable Monomer)

Examples of the cationic polymerizable monomer include epoxy compounds, oxetane compounds, oxolane compounds, cyclic acetal compounds, cyclic lactone compounds, thiirane compounds, thietane compounds, vinyl ether compounds, spiro orthoester compounds, ethylenically unsaturated bond compounds, cyclic ether compounds, cyclic thioether compounds, and vinyl compounds.

Any one of the above cationic polymerizable monomers may be used alone, or two or more may be used in any combination and at any ratio.

### (Anionic Polymerizable Monomer)

Examples of the anionic polymerizable monomers include hydrocarbon monomers and polar monomers.

Examples of the hydrocarbon monomers include styrene, α-methylstyrene, butadiene, isoprene, vinylpyridine, vinylanthracene, and derivatives thereof.

Examples of the polar monomers include methacrylic acid esters, acrylic acid esters, vinyl ketones, isopropenyl ketones, and other polar monomers.

The above-listed anionic polymerizable monomers may be used alone or in any combination and ratio of two or more.

### (Radical Polymerizable Monomer)

Examples of the radical polymerizable monomers include compounds having a (meth)acryloyl group, (meth)acrylamides, vinyl esters, vinyl compounds, styrenes, spiro ring-containing compounds, and the like. The above-listed radical polymerizable monomers may be used alone or in any combination and ratio of two or more.

In this specification, the generic term for methacryl and acrylic is(meth)acrylic, and the generic term for methacryloyl and acryloyl is(meth)acryloyl.

Among the above, compounds having a (meth)acryloyl group are more preferred from the viewpoint of steric hindrance during radical polymerization.

### (Molecular Weight of Polymerizable Monomer)

The polymerizable monomer used in the composition for holographic recording media of the present invention usually has a molecular weight of 80 or more, preferably 150 or more, more preferably 300 or more, and usually 3000 or less, preferably 2500 or less, more preferably 2000 or less. By having a molecular weight of at least the lower limit, it is possible to reduce the shrinkage rate associated with polymerization due to light irradiation during holographic information recording. By having a molecular weight of at most the upper limit, the mobility of the polymerizable monomer in the recording layer using the composition for holographic recording media is high, diffusion is easily caused, and sufficient diffraction efficiency can be obtained.

### (Refractive Index of Polymerizable Monomer)

The refractive index of the polymerizable monomer at the wavelength of light irradiated onto the holographic recording media (recording wavelength, etc.) is usually 1.50 or more, preferably 1.52 or more, more preferably 1.55 or more, and usually 1.80 or less, preferably 1.78 or less. If the refractive index is too small, the diffraction efficiency may be insufficient and the multiplicity may not be sufficient. If the refractive index is too large, the difference in refractive index with the resin matrix becomes too large, causing scattering to increase, resulting in a decrease in transmittance and requiring more energy for recording and reproduction.

Note that the refractive index shows a large value when evaluated at a short wavelength, but a sample that shows a relatively large refractive index at a short wavelength also shows a relatively large refractive index at a long wavelength, and this relationship is not reversed. Therefore, it is possible to evaluate the refractive index at a wavelength other than the recording wavelength and predict the refractive index at the recording wavelength.

If the sample is a liquid, the refractive index of a polymerizable monomer can be measured by the minimum deviation method, critical angle method, V-block method, etc. If the sample is a solid, the compound is dissolved in an appropriate solvent to make a solution, the refractive index of this solution is measured, and the refractive index when the compound is 100% can be obtained by extrapolation.

As the polymerizable monomer with high refractive index, compounds having halogen atoms (iodine, chlorine, bromine, etc.) in the molecule and compounds having heteroatoms (nitrogen, sulfur, oxygen, etc.) are preferable. Among them, those having a heterocyclic structure are more preferable.

### (Molar Absorption Coefficient of Polymerizable Monomer)

The above polymerizable monomer preferably has a molar absorption coefficient of 100 L·mol⁻¹·cm⁻¹ or less at the recording wavelength of the hologram. By having a molar absorption coefficient of 100 L·mol⁻¹·cm⁻¹ or less, it is possible to prevent the transmittance of the medium from decreasing, and to obtain sufficient diffraction efficiency for the thickness.

<Component (d)>

The photopolymerization initiator of component (d) refers to a substance that generates cations, anions, and radicals that cause a chemical reaction when exposed to light, and contributes to the polymerization of the above polymerizable monomer. There are no particular restrictions on the type of various photopolymerization initiators such as cationic photopolymerization initiators, anionic photopolymerization initiators, and radical photopolymerization initiators, and they can be selected appropriately depending on the type of polymerizable monomer, etc.

The cationic photopolymerization initiator can be any known cationic photopolymerization initiator. Examples of cationic photopolymerization initiators include aromatic onium salts. Specific examples include compounds consisting of an anion component such as SbF₆⁻, BF₄⁻, AsF₆⁻, PF₆⁻, CF₃SO₃⁻, B(C₆F₅)₄⁻, and an aromatic cationic component containing atoms such as iodine, sulfur, nitrogen, and phosphorus. Among these, diaryliodonium salts, triarylsulfonium salts, and the like are preferred. The above-listed cationic photopolymerization initiators may be used alone or in any combination and ratio of two or more.

Any known anionic photopolymerization initiator can be used as the anionic photopolymerization initiator. Examples of the anionic photopolymerization initiator include an amine, and the like. Examples of the amine include amino group-containing compounds such as dimethylbenzylamine, dimethylaminomethylphenol, 1,8-diazabicyclo[5.4.0]undecene-7, and derivatives thereof; imidazole compounds such as imidazole, 2-methylimidazole, and 2-ethyl-4-methylimidazole, and derivatives thereof.

Any one of the anionic photopolymerization initiators listed above may be used alone, or two or more may be used in any combination and at any ratio.

Any known radical photopolymerization initiator may be used as the radical photopolymerization initiator. Examples of the radical photopolymerization initiators include phosphine oxide compounds, azo compounds, azide compounds, organic peroxides, organic borates, onium salts, bisimidazole derivatives, titanocene compounds, iodonium salts, organic thiol compounds, halogenated hydrocarbon derivatives, and oxime ester compounds. The radical photopolymerization initiators exemplified above may be used alone or in any combination and ratio of two or more kinds.

Other examples of photopolymerization initiators include imidazole derivatives, oxadiazole derivatives, naphthalene, perylene, pyrene, anthracene, coumarin, chrysene, p-bis(2-phenylethenyl)benzene and their derivatives, quinacridone derivatives, coumarin derivatives, aluminum complexes such as Al(C9H6NO) 3, rubrene, perimidone derivatives, benzopyran derivatives, rhodamine derivatives, benzothioxanthene derivatives, azabenzothioxanthene, phenylpyridine complexes, porphyrin complexes, polyphenylenevinylene-based materials, and the like.

As photopolymerization initiators, compounds with a molar absorption coefficient of 1000 L·mol⁻¹·cm⁻¹ or less at the recording wavelength are particularly preferred. By having a molar absorption coefficient of 1000 L·mol⁻¹·cm⁻¹ or less, it is possible to suppress the decrease in the transmittance of the holographic recording medium at the recording wavelength that occurs when mixing an amount that provides sufficient diffraction efficiency.

<Component (e)>

As the compound having the nitroxyl radical group of component (e), a compound having an isocyanate-reactive functional group and a nitroxyl radical group is preferably used. When the composition for holographic recording media of the present invention contains such component (e), the isocyanate-reactive functional group of the component (e) reacts with the isocyanate group of the component (a) and is fixed to the resin matrix, and the nitroxyl radical group contained in the component (e) improves the recording sensitivity and realizes a high Δn.

The isocyanate-reactive functional group of component (e) can be the same as the isocyanate-reactive functional group of component (b).

The nitroxyl radical group of component (e) is preferably a stable radical group.

There is no particular limitation on the type of the component (e). Specific examples of the component (e) include, but not limited to, stable nitroxyl radical compounds such as 4-hydroxy-2,2,6,6-tetramethylpiperidine-1-oxyl (TEMPOL), 4-sulfanyl-2,2,6,6-tetramethylpiperidine-1-oxyl, 4-amino-2,2,6,6-tetramethylpiperidine-1-oxyl, 4-mercapto-2,2,6,6-tetramethylpiperidine-1-oxyl, 4-carboxy-2,2,6,6-tetramethylpiperidine-1-oxyl, 4-carbamoyl-2,2,6,6-tetramethylpiperidine-1-oxyl, 4-(2,3-epoxypropoxy)-2,2,6,6-tetramethylpiperidine-1-oxyl, 3-hydroxy-2,2,5,5-tetramethylpyrrolidine-1-oxyl, 3-sulfanyl-2,2,5,5-tetramethylpyrrolidine-1-oxyl, 3-amino-2,2,5,5-tetramethylpyrrolidine 1-oxyl, 3-mercapto-2,2,5,5-tetramethylpyrrolidine 1-oxyl, 3-carboxy-2,2,5,5-tetramethylpyrrolidine-1-oxyl, 3-carbamoyl-2,2,5,5-tetramethylpyrrolidine-1-oxyl, 3-(2,3-epoxypropoxy)-2,2,5,5-tetramethylpyrrolidine-1-oxyl, 3-hydroxy-2,2,5,5-tetramethylpyrroline-1-oxyl, 3-sulfanyl-2,2,5,5-tetramethylpyrroline-1-oxyl, 3-amino-2,2,5,5-tetramethylpyrroline-1-oxyl, 3-mercapto-2,2,5,5-tetramethylpyrroline-1-oxyl, 3-carboxy-2,2,5,5-tetramethylpyrroline-1-oxyl, 3-carbamoyl-2,2,5,5-tetramethylpyrroline-1-oxyl, 3-(2,3-epoxypropoxy)-2,2,5,5-tetramethylpyrroline-1-oxyl, and the like. However, the component (e) is not limited to these in any way.

Any one of these may be used alone, or two or more may be used in any combination and at any ratio.

Among these, from the viewpoint of the stability of the compound and the reactivity with isocyanate groups, it is preferable to use TEMPOL, 4-sulfanyl-2,2,6,6-tetramethylpiperidine-1-oxyl, 4-amino-2,2,6,6-tetramethylpiperidine-1-oxyl, and 4-mercapto-2,2,6,6-tetramethylpiperidine-1-oxyl, and it is particularly preferable to use TEMPOL.

<Component (f)>

It is preferable that the composition for holographic recording media of the present invention further contains, as component (f), a curing catalyst that promotes the reaction between component (a), a compound having an isocyanate group, and component (b), a compound having an isocyanate-reactive functional group. As the curing catalyst for component (f), it is preferable to use a bismuth-based catalyst that acts as a Lewis acid.

Examples of the bismuth catalyst include tris(2-ethylhexanoate), tribenzoyloxybismuth, bismuth triacetate, bismuth tris(dimethyldicarbamate), bismuth hydroxide, triphenylbismuth (V)bis(trichloroarrelate), tris(4-methylphenyl)oxobismuth (V), triphenylbis(3-chlorobenzoyloxy)bismuth (V), etc.

Among these, trivalent bismuth compounds are preferred in terms of catalytic activity, and bismuth carboxylate and those represented by the general formula Bi(OCOR)₃ (R is a linear or branched alkyl group, a cycloalkyl group, or a substituted or unsubstituted aromatic group) are more preferred.

The bismuth catalysts may be used alone or in any combination and ratio of two or more.

As a curing catalyst, other curing catalysts may be used in combination with the above bismuth catalysts in order to adjust the reaction rate.

There are no particular limitations on the catalysts that can be used in combination as long as they do not go against the gist of the present invention, but in order to obtain a synergistic effect of the catalysts, it is preferable to use a compound having an amino group as part of its structure. Examples of the compound having an amino group as part of their structure include an amine compound such as triethylamine (TEA), N, N-dimethylcyclohexylamine (DMEDA), N, N,N′, N′-tetramethylethylenediamine (TMEDA), N, N,N′, N′-tetramethylpropane-1,3-diamine (TMPDA), N, N,N′, N′-tetramethylhexane-1,6-diamine (TMHMDA), N, N,N′, N″, N″-pentamethyldiethylenetriamine (PMDETA), N, N,N′, N″, N″-pentamethyldipropylene-triamine (PMDPTA), triethylenediamine (TEDA), N,N′-dimethylpiperazine (DMP), N-methyl, N′-(2-dimethylamino)-ethylpiperazine (TMNAEP), N-methylmorpholine (NMMO), N. (N′, N′-dimethylaminoethyl)-morpholine (DMAEMO), bis(2-dimethylaminoethyl) ether (BDMEE), ethylene glycol bis(3-dimethyl)-aminopropyl ether (TMEGDA), and diisopropylethylamine (DIEA).

Any one of these may be used alone, or two or more may be used in any combination and at any ratio.

### <Additional Components>

The composition for holographic recording media of the present invention may contain other components in addition to the above-mentioned components (a) to (f), as long as they do not go against the gist of the present invention.

Examples of the additional components include solvents, plasticizers, dispersants, leveling agents, defoamers, and adhesion promoters for preparing the recording layer of the holographic recording medium; and chain transfer agents, polymerization terminators, compatibilizers, reaction aids, sensitizers, and antioxidants for controlling the recording reaction.

Any one of these components may be used alone, or two or more may be used in any combination and at any ratio.

### <Composition Ratio of Each Component in the Composition for Holographic Recording Media>

The content of each component in the composition for holographic recording media of the present invention is arbitrary as long as it does not go against the gist of the present invention. However, it is preferable that the content of each component is within the following range.

The content of component (a) in the composition for holographic recording media of the present invention is usually 10% by mass or more, preferably 208 by mass or more, and more preferably 30% by mass or more. It is also usually 85% by mass or less, preferably 75% by mass or less, and more preferably 658 by mass or less.

When the content of component (a) is equal to or greater than the lower limit, mixing with component (b) becomes easy. When the content of component (a) is equal to or less than the upper limit, mixing with component (b) becomes easy.

The content of component (b) in the composition for holographic recording media of the present invention is usually 10% by mass or more, preferably 20% by mass or more, and more preferably 30% by mass or more. It is also usually 85% by mass or less, preferably 75% by mass or less, and more preferably 65% by mass or less.

When the content of component (b) is equal to or greater than the lower limit, mixing with component (a) becomes easy. When the content of component (b) is equal to or less than the upper limit, mixing with component (a) becomes easy.

The total content of components (a) and (b) in the composition for holographic recording media of the present invention is usually 20% by mass or more, preferably 25% by mass or more, more preferably 30% by mass or more, and even more preferably 35% by mass or more. Also, it is usually 99.9% by mass or less, preferably 99% by mass or less, and more preferably 98% by mass or less.

By making the total content of components (a) and (b) equal to or more than the above lower limit, it becomes easy to form a recording layer. By making the total content of components (a) and (b) equal to or less than the above upper limit, it is possible to ensure the content of other essential components.

In the composition for holographic recording media of the present invention, it is preferable that the ratio of the number of isocyanate-reactive functional groups of component (b) to the number of isocyanate groups of component (a) is 0.1 or more, more preferably 0.5 or more. Also, usually, this ratio is 10.0 or less, and preferably 2.0 or less. By making this ratio within the above range, the number of unreacted functional groups is small, and storage stability is improved.

The content of component (c) in the composition for the holographic recording media of the present invention is usually 0.1% by mass or more, preferably 18 by mass or more, and more preferably 2% by mass or more. Also, it is usually 80% by mass or less, preferably 50% by mass or less, more preferably 30% by mass or less. When the content of component (c) is equal to or more than the lower limit, sufficient diffraction efficiency can be obtained. When the content of component (c) is equal to or less than the upper limit, the compatibility of the recording layer is maintained.

The content of component (d) in the composition for the holographic recording media of the present invention is usually 0.1% by mass or more, preferably 0.2% by mass or more, more preferably 0.3% by mass or more, based on the content of component (c). Also, it is usually 20% by mass or less, preferably 18% by mass or less, more preferably 16% by mass or less. When the content of component (d) is equal to or more than the lower limit, sufficient recording sensitivity can be obtained. When the content of component (d) is equal to or less than the upper limit, the decrease in sensitivity caused by bimolecular termination reaction due to excessive radical generation can be suppressed.

The content of component (e) in the composition for the holographic recording media of the present invention is preferably such that the molar ratio of component (e) to the component (d) (component (e)/component (d)) is usually 0.1 or more, particularly 0.2 or more, and especially 0.3 or more, and usually 10 or less, particularly 8 or less, and especially 6 or less. When the component (e)/component (d) is equal to or more than the above lower limit, the effect of improving Δn by containing the component (e) can be effectively obtained. When the component (e)/component (d) is equal to or less than the above upper limit, a radical polymerization reaction is allowed to proceed during exposure for recording, a refractive index modulation degree required for the formation of a diffraction grating is obtained, and sufficient recording sensitivity is obtained.

The content of the component (f) in the composition for the holographic recording media of the present invention is preferably determined in consideration of the reaction rate of the components (a) and (b), and is usually 5% by mass or less, preferably 4% by mass or less, and more preferably 18 by mass or less. The content of component (f) in the composition for holographic recording media of the present invention is preferably 0.001% by mass (10 ppm) or more.

The total content of other components other than the components (a) to (f) in the composition for the holographic recording media of the present invention may be 30% by mass or less, preferably 15% by mass or less, and more preferably 5% by mass.

### <Method for Producing a Cured Product for Holographic Recording Media>

In the method for producing a cured product for holographic recording media of the present invention, the above-mentioned components (a) to (e), preferably the components (a) to (f), are mixed to produce the composition for holographic recording media of the present invention, and the composition is cured.

In producing the composition for holographic recording media of the present invention, components (a)-(e), preferably the components (a)-(f), may be mixed in any combination and order, and other components may be mixed in combination.

The mixture for the composition for holographic recording media produced is usually applied to a support, described below, and cured according to the method for producing a holographic recording media described below.

In the mixture for the composition for holographic recording media, the curing reaction proceeds quickly even at room temperature by increasing the content of component (f). As the curing proceeds, the fluidity of the mixture decreases, so it takes a long time to cure until the reaction is completed at room temperature. Therefore, it is preferable to perform a heat treatment as a post-treatment.

In the present invention, the curing reaction of the composition for holographic recording media is performed in a curing step A in which the curing reaction is performed at less than 35° C. Preferably, the curing reaction in the present invention includes this curing step A and a curing step B in which the composition is cured at 35° C. or higher, and it is preferable to perform the curing step B after the curing step A.

In the method for producing a cured product for a holographic recording medium of the present invention, curing in the curing step A is performed until the NCO residual rate of the composition for a holographic recording medium is 10% or less. That is, by reducing the NCO residual rate to 10% or less in the curing step A and preferably performing the curing step B thereafter, a cured product for a holographic recording medium with a small three-dimensional birefringence can be obtained.

The NCO residual rate in the present invention is expressed as a percentage of the concentration of unreacted NCO relative to the concentration of reactable isocyanate groups (NCO) in the composition for a holographic recording medium before the curing reaction, i.e., immediately after production. For example, in the case of a composition that originally has an excess of isocyanate groups, such as the ratio of the number of isocyanate-reactive functional groups of component (b) to the number of isocyanate groups of component (a) being 0.5, not all of the isocyanate groups are reactable, and half of the isocyanate groups in the composition for a holographic recording medium are reactable, but the remaining half are NCOs that are originally unreactable. For this reason, NCO that cannot react is not included in the calculation of the NCO residual ratio.

In the present invention, the lower the NCO residual ratio after the curing step A, the lower the three-dimensional birefringence after the subsequent curing step B tends to be. The reason is as follows.

When the curing step B is performed as a post-treatment in a state where the NCO residual ratio of the composition for holographic recording media is high, the curing reaction of the matrix resin reaches convergence in a high-temperature environment. However, after that, it is cooled to room temperature, so thermal shrinkage occurs. At this time, since at least one side of the matrix resin is bonded to the substrate material of the support as described later, only thermal shrinkage following the substrate material occurs in the surface direction of the adhesive surface. On the other hand, in the thickness direction, a larger thermal shrinkage occurs, including the amount in the planar direction. At this time, some of the components that have reacted to cure at a high temperature in the curing step B are arranged in the thickness direction as stress relaxation. As a result, the thickness direction and the surface direction have different refractive indices, and the three-dimensional birefringence increases. This tendency is greater the higher the NCO residual ratio before the curing step B after the curing step A is performed.

For the above reasons, the NCO residual ratio after the curing step A in the present invention is 10% or less, and preferably 6% or less. With such an NCO residual ratio, even if the curing step B is performed at 35° C. or higher, it is possible to obtain a cured product for a holographic recording medium with a small three-dimensional birefringence. There is no particular limit to the lower limit of this NCO residual ratio, but it is usually preferable to set it to 0.1% or more, and particularly 18 or more, since reducing the NCO residual ratio by the curing reaction in the curing step A at less than 35° C. takes a long time and is inefficient, and even if the time of the curing step A is extended, there are cases where the NCO residual ratio does not decrease any further.

The NCO residual ratio can be measured by the method described in the Examples section below.

In the present invention, the temperature condition in the curing step A is less than 35° C. From the viewpoint of efficiently reducing the NCO residual ratio, the lower limit of the temperature condition under non-heating in the curing step A is preferably 10° C. or higher, and more preferably 15° C. or higher.

Furthermore, from the viewpoint of reducing the three-dimensional birefringence, the upper limit of the temperature condition in the curing step A is preferably 30° C. or less, and more preferably 25° C. or less.

This curing step A is usually carried out without heating.

If the room temperature during the curing reaction in the curing step A is excessively high, the temperature may be within the above-mentioned range by cooling as necessary.

As described above, the curing step A is carried out for such a time that the NCO residual rate is 10% or less, preferably 6% or less, and 0.1% or more, preferably 1% or more.

The time for this curing step A varies depending on the amount of curing catalyst in the composition for the holographic recording media, and is not particularly limited, but is usually about 0.1 to 240 hours.

In the present invention, the temperature in the curing step B after the curing step A is preferably 35° C. or higher. From the viewpoint of the time required for the reaction to converge and the prevention of deterioration of the matrix resin itself, the lower limit of the processing temperature in the curing step B after the curing step A is preferably 35° C. or higher, more preferably 50° C. or higher, and even more preferably 65° C. or higher. Furthermore, the upper limit of the processing temperature in the curing step B after the curing step A is preferably 150° C. or lower, more preferably 120° C. or lower, and even more preferably 100° C. or lower.

Therefore, in the curing step B, heating is performed so as to reach the above-mentioned suitable temperature.

The shorter the processing time in the curing step B, the better, taking into consideration the manufacturing takt time. However, when it is too short, sufficient effect as a post-processing cannot be obtained. For this reason, the processing time in the curing step B is preferably 15 minutes or more, more preferably 1 hour or more, even more preferably 6 hours or more, and usually 72 hours or less.

The NCO residual rate after the curing step B is preferably 1% or less, particularly 0 to 0.4%.

The cured product for a holographic recording medium of the present invention can also be used to manufacture a holographic recording medium according to the method for forming a recording layer in the manufacturing method for a holographic recording medium described later.

### [Holographic Recording Medium]

A holographic recording medium can be obtained by subjecting the cured product for a holographic recording medium of the present invention to interference exposure.

Hereinafter, a holographic recording medium using the cured product for holographic recording media of the present invention may be referred to as the holographic recording medium of the present invention.

A preferred embodiment of the holographic recording medium of the present invention will be described hereinbelow.

The holographic recording medium of the present invention comprises a recording layer and at least a support and other layers. Usually, a holographic recording medium has at least one support, and the recording layer and other layers are laminated on this support to constitute the holographic recording medium. Examples of other layers include a protective layer, a reflective layer, an anti-reflective layer (anti-reflective film), and the like.

### <Recording Layer>

The recording layer of the holographic recording medium of the present invention is a layer formed by the cured product for holographic recording media of the present invention, and is a layer in which information is recorded. Information is usually recorded as a hologram. As will be described in detail in the recording method section below, a part of the polymerizable monomer contained in the recording layer undergoes a chemical change such as polymerization due to holographic recording, etc. Therefore, in the holographic recording medium after recording, a part of the polymerizable monomer is consumed, and exists as a compound after reaction such as a polymer.

There is no particular limitation on the thickness of the recording layer, and it may be appropriately determined in consideration of the recording method, etc., but in general, it is usually 1 μm or more, preferably 10 μm or more, and usually 3000 μm or less, preferably 2000 μm or less. By making the thickness of the recording layer equal to or greater than the above lower limit, the selectivity of each hologram is increased during multiple recording in the holographic recording medium, and the degree of multiple recording can be increased. By making the thickness of the recording layer equal to or less than the above upper limit, it is possible to uniformly mold the entire recording layer, and multiple recording can be performed with uniform diffraction efficiency of each hologram and a high S/N ratio.

The shrinkage rate of the recording layer due to exposure during recording and reproduction of information is preferably 0.5% or less.

### <Support>

There is no particular limitation on the details of the support, and any support can be used as long as it has the strength and durability required for the medium. There is no particular limitation on the shape of the support, but it is usually formed into a flat plate or film.

There is no restriction on the material constituting the support, and it may be transparent or opaque.

Examples of the transparent material for the support include organic materials such as acrylic, polyethylene terephthalate, polyethylene naphthoate, polycarbonate, polyethylene, polypropylene, amorphous polyolefin, polystyrene, and cellulose acetate; and inorganic materials such as glass, silicon, and quartz. Among these, polycarbonate, acrylic, polyester, amorphous polyolefin, and glass are preferred, and polycarbonate, acrylic, amorphous polyolefin, and glass are more preferred.

On the other hand, examples of the opaque material for the support include metals such as aluminum; the above-mentioned transparent support coated with metals such as gold, silver, and aluminum, or with dielectrics such as magnesium fluoride and zirconium oxide.

There is no restriction on the thickness of the support, but it is usually preferred that it be in the range of 0.05 mm or more and 1 mm or less. When the thickness of the support is equal to or greater than the lower limit, the mechanical strength of the holographic recording medium can be obtained, and warping of the substrate can be prevented. When the thickness of the support is equal to or less than the upper limit, the amount of light transmission can be maintained, and an increase in costs can be suppressed.

The surface of the support may be subjected to a surface treatment. This surface treatment is usually performed to improve the adhesion between the support and the recording layer. Examples of surface treatments include subjecting the support to a corona discharge treatment, or forming an undercoat layer on the support in advance. Here, examples of compositions for the undercoat layer include halogenated phenols, partially hydrolyzed vinyl chloride-vinyl acetate copolymers, polyurethane resins, and the like.

The surface treatment of the support may be performed for purposes other than improving adhesion. Examples thereof include a reflective coating treatment for forming a reflective coating layer made of a metal such as gold, silver, or aluminum; and a dielectric coating treatment for forming a dielectric layer made of magnesium fluoride, zirconium oxide, or the like. These layers may be formed as a single layer, or two or more layers may be formed.

These surface treatments may be performed for the purpose of controlling the gas or moisture permeability of the substrate. For example, the reliability of the medium can be further improved by providing the support sandwiching the recording layer with a function of suppressing the gas or moisture permeability.

The support may be provided only on either the upper or lower side of the recording layer of the holographic recording medium of the present invention, or on both sides. However, when supports are provided on both the upper and lower sides of the recording layer, at least one of the supports is configured to be transparent so as to transmit active energy rays (excitation light, reference light, reproduction light, etc.).

In the case of a holographic recording medium having a support on one or both sides of the recording layer, a transmission type or reflection type hologram can be recorded. In addition, when a support having a reflection characteristic is used on one side of the recording layer, a reflection type hologram can be recorded.

The support may be provided with a pattern for data addressing. In this case, there is no limitation on the patterning method, but for example, unevenness may be formed on the support itself, a pattern may be formed on the reflective layer described later, or a combination of these methods may be used.

### <Protective Layer>

The protective layer is a layer for preventing influences of oxygen and moisture on the recording layer, such as a decrease in sensitivity and deterioration of storage stability. There is no limitation on the specific configuration of the protective layer, and any known material can be used. For example, a layer made of a water-soluble polymer, organic/inorganic material, etc. can be formed as the protective layer.

There is no particular limitation on the position where the protective layer is formed, and it may be formed, for example, on the surface of the recording layer, between the recording layer and the support, or on the outer surface side of the support. The protective layer may be formed between the support and another layer.

### <Anti-Reflection Film>

For both transmission type and reflection type holographic recording media, an anti-reflection film may be provided on the side where the object light and readout light enter and exit, or between the recording layer and the support. The anti-reflection film improves the light utilization efficiency and suppresses the occurrence of ghost images.

Any known anti-reflection film can be used.

### <Manufacturing Method of Holographic Recording Medium>

There is no limitation on the manufacturing method of the holographic recording medium of the present invention. For example, the composition for holographic recording medium of the present invention can be applied to a support without a solvent, and then subjected to a curing reaction according to the present invention to form a recording layer.

Any method can be used to apply the composition for holographic recording medium. Specific examples include spraying, spin coating, wire bar coating, dipping, air knife coating, roll coating, blade coating, and doctor roll coating.

When forming a recording layer, particularly when a thick recording layer is to be formed, a method of molding the composition for holographic recording medium of the present invention by putting it into a mold, or a method of applying it onto a release film and punching out a mold can be used.

The composition for holographic recording medium of the present invention can be mixed with a solvent or additive to prepare a coating liquid, which can be applied to a support and dried to form a recording layer. In this case, any method can be used as the coating method. For example, the same method as described above can be adopted.

There are no limitations to the solvent used in the coating solution, but it is usually preferable to use one that has sufficient solubility for the components used, provides good coating properties, and does not damage the supports such as resin substrates.

Examples of solvents include ketone-based solvents such as acetone and methyl ethyl ketone; aromatic solvents such as toluene and xylene; alcohol-based solvents such as methanol and ethanol; ketone alcohol-based solvents such as diacetone alcohol; ether-based solvents such as tetrahydrofuran; halogen-based solvents such as dichloromethane and chloroform; cellosolve-based solvents such as methyl cellosolve and ethyl cellosolve; propylene glycol-based solvents such as propylene glycol monomethyl ether and propylene glycol monoethyl ether; ester-based solvents such as ethyl acetate and methyl 3-methoxypropionate; perfluoroalkyl alcohol-based solvents such as tetrafluoropropanol; highly polar solvents such as dimethylformamide and dimethyl sulfoxide; chain hydrocarbon-based solvents such as n-hexane; cyclic hydrocarbon-based solvents such as cyclohexane and cyclooctane; or mixed solvents of these.

These solvents may be used alone or in any combination and ratio of two or more.

There is no limit to the amount of solvent used. In terms of coating efficiency and ease of handling, it is preferable to prepare a coating solution with a solid content concentration of about 1 to 100% by mass.

The holographic recording medium thus produced can take the form of a self-supporting slab or disk, and can be used in three-dimensional image display devices, diffractive optical elements, large-capacity memories, and other applications.

The holographic recording medium of the present invention, which has a recording layer made of a cured product for a holographic recording medium with a small three-dimensional birefringence produced according to the present invention, has a high Δn, reduces color unevenness, and improves brightness, and is useful as a light guide plate for AR glasses.

### <Large-Capacity Memory Applications>

Information is written (recorded) and read (reproduced) on the holographic recording medium of the present invention by irradiation with light.

When recording information, light capable of causing chemical changes in the polymerizable monomer, i.e., its polymerization and concentration change, is used as the object light.

For example, when recording information as a volume hologram, the object light is irradiated onto the recording layer together with the reference light, and the object light and the reference light are made to interfere with each other in the recording layer. This causes the interference light to cause polymerization and concentration changes in the polymerizable monomer in the recording layer, and as a result, the interference fringes cause a refractive index difference in the recording layer, and the interference fringes recorded in the recording layer are recorded as a hologram in the recording layer.

When reproducing a volume hologram recorded in the recording layer, a specified reproduction light (usually a reference light) is irradiated onto the recording layer. The irradiated reproduction light is diffracted in accordance with the interference fringes. This diffracted light contains the same information as the recording layer, so the information recorded in the recording layer can be reproduced by reading the diffracted light using an appropriate detection means.

The wavelength range of the object light, the reproduction light, and the reference light is arbitrary depending on the application, and may be either the visible light range or the ultraviolet range. Among these lights, suitable ones include, for example, solid-state lasers such as ruby, glass, Nd-YAG, and Nd-YVO₄; diode lasers such as GaAs, InGaAs, and GaN; gas lasers such as helium-neon, argon, krypton, excimer, and CO₂; and dye lasers having excellent monochromaticity and directivity.

There is no limit to the amount of irradiation of the object light, the reproduction light, and the reference light, and the amount of irradiation is arbitrary as long as recording and reproduction are possible. When the amount of irradiation is extremely small, the chemical change of the polymerizable monomer may be incomplete, and the heat resistance and mechanical properties of the recording layer may not be fully expressed. Conversely, when the amount of irradiation is extremely large, the components of the recording layer (components of the composition for holographic recording media) may deteriorate. Therefore, the object light, the reproducing light, and the reference light are usually irradiated in the range of 0.1 J/cm² or more and 20 J/cm² or less according to the composition of the holographic recording medium composition used to form the recording layer, the type of photopolymerization initiator, and the amount of the photopolymerization initiator.

There are polarized collinear holographic recording methods and reference light incident angle multiplexed holographic recording methods. When the holographic recording medium of the present invention is used as a recording medium, any of the recording methods can provide good recording quality.

### <Application to AR Glass Light Guide Plate (Application to AR Glasses Light Guide Plate)>

A volume hologram is recorded on the holographic recording medium of the present invention in the same manner as the large-capacity memory application described above.

For the volume hologram recorded in the recording layer, a specified reproducing light is irradiated onto the recording layer. The irradiated reproducing light is diffracted according to the interference fringes. In this case, even if the wavelength of the reproducing light does not match the wavelength of the recording light, diffraction occurs if the interference fringes and the Bragg condition are established. Therefore, if the corresponding interference fringes are recorded according to the wavelength and incident angle of the reproducing light to be diffracted, diffraction can be caused for the reproducing light in a wide wavelength range, and the display color range of the AR glass can be increased.

If the corresponding interference fringes are recorded according to the wavelength and diffraction angle of the reproducing light, the reproducing light incident from outside the hologram recording medium can be guided inside the hologram recording medium, the reproducing light that has been guided inside the hologram recording medium can be reflected, split, enlarged, or reduced, and the reproducing light that has been guided inside the hologram recording medium can be emitted outside the hologram recording medium, and the viewing angle of the AR glass can be increased.

The wavelength range of the object light and the reproducing light is arbitrary depending on the respective applications, and may be either the visible light range or the ultraviolet range. Among these lights, the aforementioned laser and the like are suitable, but the reproducing light is not limited to the laser, and display devices such as liquid crystal displays (LCDs) and organic electroluminescence displays (OLEDs) are also suitable.

There is no limit to the amount of irradiation of the object light, the reproduction light, and the reference light, and the amount of irradiation is arbitrary as long as recording and reproduction are possible. When the amount of irradiation is extremely small, the chemical change of the polymerizable monomer may be too incomplete, and the heat resistance and mechanical properties of the recording layer may not be fully expressed. Conversely, when the amount of irradiation is extremely large, the components of the recording layer (components of the composition for holographic recording media) may deteriorate. Therefore, the object light, the reproduction light, and the reference light are usually irradiated in the range of 0.1 J/cm² or more and 20 J/cm² or less, depending on the composition of the composition for holographic recording media of the present invention used to form the recording layer, the type of photopolymerization initiator, and the amount of the photopolymerization initiator used.

### <Three-Dimensional Birefringence>

In the present invention, the three-dimensional birefringence δn shown in the following formulas (1) to (3) is used as an index of three-dimensional birefringence. The smaller this δn, the less the polarization component of the guided light changes, and the diffracted light intensity of the intended holographic recording can be obtained as an AR glass light guide plate. Therefore, δn is preferably 2.1×10⁻⁴ or less, and more preferably 1.0×10⁻⁴ or less. Here, δn can be a negative integer depending on how the polarization angle of the measurement incident light is tilted, but in the present invention, the magnitude relationship of δn is important, so the polarization angle is tilted so that δn>0.

$$[ Equation 1 ]$$

$$δ n = \frac{Δ \cdot λ}{2 π \cdot d} \qquad ( 1 )$$

$$d = \frac{T}{cos ( {sin}^{- 1} ( {n}_{0} / {n}_{1} sin ϕ ) )} \qquad ( 2 )$$

$$Δ = {tan}^{- 1} ( tan θ \cdot tan ψ ) + {tan}^{- 1} ( \frac{tan ψ}{tan θ} ) \qquad ( 3 )$$

(In the formula, Δ is the phase difference. d is the distance the measurement light has passed through. λ is the wavelength of the measurement light. T is the thickness of the optical element. n₀ is the absolute refractive index of air. n₁ is the absolute refractive index of the optical element. φ is the incidence angle of the measurement incident light. θ is the polarization angle of the measurement light after passing through the optical element. ψ indicates the ellipticity of the measurement light after passing through the optical element. θ and γ are measured using a birefringence difference measuring device described later.) Examples

The present invention will be described in more detail below with reference to examples. The present invention is not limited to the following examples as long as it does not deviate from the gist of the invention.

### [Raw Materials Used]

The raw materials used in the Examples and Comparative Examples are as follows.

In the following Examples and Comparative Examples, a composition for a holographic recording medium was prepared containing only component (a): a compound (a) having an isocyanate group, component (b): a compound (b) having an isocyanate-reactive functional group, and component (f): a curing catalyst. This is for investigating the three-dimensional birefringence due to thermal shrinkage in the curing reaction. For practical use, a composition for a holographic recording medium preferably contains the above-mentioned components (a) to (e), especially components (a) to (f).

### (Compounds Having Isocyanate Groups (a))

Duranate™MTSS-100: Hexamethylene diisocyanate polyisocyanate (NCO 17.6%) (manufactured by Asahi Kasei Corporation)
Takenate 600: Aliphatic diisocyanate (NCO 43.3%) (manufactured by Mitsui Chemicals, Inc.)

### (Compounds Having Isocyanate Reactive Functional Groups (b))

Placcel PCL-305: Polycaprolactone triol (molecular weight 550) (manufactured by Daicel Corporation)
Capa 2047A: Polycaprolactone diol (molecular weight 400) (manufactured by Ingevity Corporation)

### (Curing Catalyst)

Tris(2-ethylhexyl)Bismuth (2-ethylhexanoate) in octylic acid solution (active ingredient amount 56 mass %)

### Examples 1-12, Comparative Examples 1-3

### Preparation of Composition for Holographic Recording Media

2.1119 g of Duranate™MTSS-100, 0.3727 g of Takenate 600, 2.2639 g of Capa 2047A, and 0.2515 g of PCL-305 were mixed (the amount of isocyanate-reactive functional groups relative to the amount of isocyanate groups was 1.0 times) (the resulting mixture is referred to as the “initial mixture”), and a solution of tris(2-ethylhexanoate) bismuth in octylic acid was added in the amount of curing catalyst shown in Table 1, and the mixture was stirred and mixed to obtain a mixture for a composition for holographic recording media.

### <Production of a Cured Product for Holographic Recording Media>

The above mixture of compositions for holographic recording media was poured onto a glass slide, the glass slide being provided with 1.0 mm thick spacer sheets on two opposing sides. The another glass slide was placed thereon and the periphery of the glass slide was fixed with clips.

The cured product A with a thickness of 1.0 mm was formed by performing the curing step A. As shown in Table 1, when the amount of curing catalyst was 40 ppm, 80 ppm, 120 ppm, 160 ppm, 200 ppm, and 240 ppm, the curing time at room temperature (24° C.) before heat treatment was set to 24, 96, and 168 hours in the curing step A. The NCO residual ratio of the formed cured product A (NCO residual ratio after the curing step A) was measured by the method described below, and then the curing was completed by performing the curing step B at 80° C. for 24 hours. The three-dimensional birefringence of the obtained cured product B was measured by the method described below.

### <Measurement of NCO Residual Ratio>

The NCO residual ratio of the cured material A before 24 hours of heat treatment at 80° C. was calculated by using a NICOLET™ iS™ 5 (manufactured by THERMO FISHER SCIENTIFIC Corporation) with reference to the method described in Non-Patent Literature 1, from the intensity ratio of the absorption peak at 2267 cm⁻¹ due to the isocyanate group, with the absorption peak at 2859 cm⁻¹ due to the CH bond that does not change upon curing as the reference. The intensity ratio of the isocyanate group of the initial mixed solution before the curing reaction, which did not contain a curing catalyst within 30 minutes of preparation of the initial mixed solution, was used as the NCO residual ratio of 100%.

### <Measurement of Three-Dimensional Birefringence>

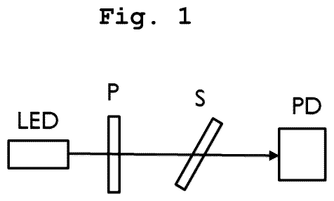

FIG. 1 shows a schematic diagram of the birefringence measurement device used to measure three-dimensional birefringence. In FIG. 1, S denotes the prepared cured product for holographic recording media (cured product B), which is tilted so that the measurement light is incident at an angle of 70°. LED is a measurement LED light source (M455L4 manufactured by ThorLab Corporation) with a central wavelength of 455 nm. P denotes a polarizing plate, which is arranged so that the incident measurement light is linearly polarized at 45°. PD denotes a birefringence measurement sensor (PAX1000VIS manufactured by ThorLab Corporation). From the measurement results, the three-dimensional birefringence on was calculated using the above formulas (1) to (3).

### <Evaluation Results>

Table 1 shows the NCO residual rate of cured product A and the three-dimensional birefringence on of cured product B. Table 1 also shows the results of evaluation of the three-dimensional birefringence on according to the following criteria.

### <Evaluation Criteria>

Evaluation was performed according to the following criteria based on the three-dimensional birefringence on.
very good: δn<1.0×10⁻⁴
good: 1.0×10⁻⁴≤δn≤2.1×10⁻⁴
not good: 2.1×10⁻⁴<δn

TABLE 1

| | | | NCO | | |
|---|---|---|---|---|---|
| | | Curing | residual | | |
| | Amount of | time in | rate of | Three- | |
| | curing | curing | cured | dimensional | |
| | catalyst | step A | product | birefringence | Evalua- |
| | (ppm) | (hr) | A (%) | δn | tion |
| Example 1 | 160 | 24 | 9 | 2.1 × 10⁻⁴ | good |
| Example 2 | 200 | 24 | 8 | 1.8 × 10⁻⁴ | good |
| Example 3 | 240 | 24 | 7 | 1.3 × 10⁻⁴ | good |
| Example 4 | 40 | 96 | 5 | 7.3 × 10⁻⁵ | very good |
| Example 5 | 80 | 96 | 5 | 9.9 × 10⁻⁵ | very good |
| Example 6 | 120 | 96 | 3 | 8.3 × 10⁻⁵ | very good |
| Example 7 | 160 | 96 | 6 | 4.8 × 10⁻⁵ | very good |
| Example 8 | 200 | 96 | 5 | 3.3 × 10⁻⁵ | very good |
| Example 9 | 240 | 96 | 5 | 9.6 × 10⁻⁶ | very good |
| Example 10 | 40 | 168 | 5 | 4.4 × 10⁻⁵ | very good |
| Example 11 | 80 | 168 | 4 | 5.2 × 10⁻⁵ | very good |
| Example 12 | 120 | 168 | 6 | 3.7 × 10⁻⁵ | very good |
| Comparative | 40 | 24 | 22 | 2.4 × 10⁻⁴ | not good |
| Example 1 | | | | | |
| Comparative | 80 | 24 | 19 | 2.6 × 10⁻⁴ | not good |
| Example 2 | | | | | |
| Comparative | 120 | 24 | 14 | 2.6 × 10⁻⁴ | not good |
| Example 3 | | | | | |

### DISCUSSION

From the above Examples and Comparative Examples, it can be seen that by performing the curing step A so that the NCO residual rate of the cured product Δ is 10% or less, the three-dimensional birefringence of the cured product B obtained in the subsequent curing step B is significantly reduced. In particular, it can be seen that the three-dimensional birefringence is further reduced under conditions where the NCO residual rate after the curing step Δ is 6% or less.

### INDUSTRIAL APPLICABILITY

The manufacturing method of the cured product for a holographic recording medium of the present invention is useful as a means for reducing the three-dimensional birefringence, particularly in optical elements in which holograms are recorded.

Although the present invention has been described in detail using specific embodiments, it is clear to those skilled in the art that various modifications are possible within the scope of the invention.

This application is based on Japanese Patent Application No. 2022-181979 filed on Nov. 14, 2022, the entire contents of which is incorporated by reference.

### REFERENCE SIGNS LIST

S: Hardened material for holographic recording media
P: Polarizing plate
LED: LED light source for measurement
PD: Birefringence measurement sensor

1. A method for producing a cured product for a holographic recording medium comprising:
performing a curing reaction for by curing a composition for a holographic recording medium,
wherein the composition comprises a compound (a) having an isocyanate group and a compound (b) having an isocyanate-reactive functional group,
the curing reaction includes a curing step A in which the composition is cured at a temperature lower than 35° C., and
a remaining rate of unreacted isocyanate groups after the curing step Δ is 10% or less relative to the isocyanate groups in the composition for a holographic recording medium before the curing reaction.

2. The method for producing a cured product for a holographic recording medium according to claim 1, wherein
the curing reaction includes a curing step B in which the composition is cured at a temperature of 35° C. or higher.

3. The method for producing a cured product for a holographic recording medium according to claim 2, wherein the temperature of the curing step B is 150° C. or lower.

4. The method for producing a cured product for a holographic recording medium according to claim 1, wherein the composition for a holographic recording medium comprises a bismuth-based catalyst as a component (f).

5. The method for producing a cured product for a holographic recording medium according to claim 4, wherein the bismuth-based catalyst is at least one compound selected from the group consisting of tris(2-ethylhexanate)bismuth, tribenzoyloxybismuth, bismuth triacetate, bismuth tris(dimethyldicarbamate), bismuth hydroxide, triphenylbismuth (V)bis(trichloroarrelate), tris(4-methylphenyl)oxobismuth (V), and triphenylbis(3-chlorobenzoyloxy)bismuth (V).

6. The method for producing a cured product for a holographic recording medium according to claim 4, wherein the content of the component (f) in the composition for a holographic recording medium is 0.001% by mass or more and 5% by mass or less.

7. The method for producing a cured product for a holographic recording medium according to claim 1, wherein the compound (b) having an isocyanate-reactive functional group has one or more hydroxyl groups in one molecule.

8. The method for producing a cured product for a holographic recording medium according to claim 1, wherein the compound (b) having an isocyanate-reactive functional group is at least one compound having two or more hydroxyl groups in one molecule selected from the group consisting of polyester polyols, polyether polyols, and polycarbonate polyols.

9. The method for producing a cured product for a holographic recording medium according to claim 1, wherein the compound (b) having an isocyanate-reactive functional group is at least one compound selected from polycaprolactone polyols having two or more hydroxyl groups in one molecule.

10. The method for producing a cured product for a holographic recording medium according to claim 1, wherein the content of the compound (b) having an isocyanate-reactive functional group in the composition for a holographic recording medium is 10% by mass or more and 85% by mass or less.

11. The method for producing a cured product for a holographic recording medium according to claim 1, wherein the compound (a) having an isocyanate group is at least one compound selected from polyisocyanates having an isocyanurate structure.

12. The method for producing a cured product for a holographic recording medium according to claim 1, wherein the content of the compound (a) having an isocyanate group in the composition for a holographic recording medium is 10% by mass or more and 85% by mass or less.
